(19) United States
(12) Patent Application Publication
(10) Pub. No.: US 2026/0121471 A1
(43) Pub. Date: Apr. 30, 2026

(54) ROTOR WITH SELF-SECURING END PLATE

(71) Applicant: FORD GLOBAL TECHNOLOGIES, LLC, Dearborn, MI (US)

(72) Inventor: Matthew Schmitt, Salt Lake City, UT (US)

(21) Appl. No.: 18/929,990

(22) Filed: Oct. 29, 2024

(51) Int. Cl. H02K 1/28; H02K 15/02

(52) U.S. Cl. CPC H02K 1/28; H02K 15/02

(57) ABSTRACT

A permanent magnet synchronous motor includes a rotor. The rotor is formed by sliding rotor plates and end plates onto a rotor shaft. At least one of the end plates is secured axially to the rotor shaft by rotating it such that a key engages a circumferential keyway in the shaft. An axial keyway allows the end plate to slide to the circumferential keyway. The axial keyway may also function to rotationally fix the rotor plates to the shaft. The second end plate may be axially secured in a similar fashion or may be axially secured by a shoulder.

### TECHNICAL FIELD

This disclosure pertains to electric motors. More particularly, this disclosure pertains to a permanent magnet motor having at least one end plate secured by a circumferential keyway.

### BACKGROUND

Many electrified vehicles utilize permanent magnet synchronous traction motors. A permanent magnet synchronous traction motor includes a rotor having a plurality of rotor plates fixed to a rotor shaft. The rotor plates are made of a magnetically conductive material and have pockets into which permanent magnets are installed to establish a pattern of alternating North and South magnetic fields around the circumference. These magnetic fields interact with magnetic fields produced by electrical currents in the motors stator to create torque on the rotor shaft. The rotor may also include end plates, which are not necessarily made of magnetically conductive material. The end plates may be positioned axially by a combination of snap rings and bolts that extend through the rotor plates.

### SUMMARY

A rotor includes a shaft, a first end plate, and at least one rotor plate. The shaft defines a first circumferential keyway and a first axial keyway. The first axial keyway extends from a first step in the shaft at least to the first circumferential keyway. The first circumferential keyway may extend only partially around the shaft. The first circumferential keyway may define a notch facing toward the first step in the shaft. The first end plate has a first internal key located in the first circumferential keyway to prevent axial movement of the first end plate. The first internal key may be located in the notch. The rotor plates are rotationally fixed to the shaft on a side of the first end plate opposite the step in the shaft. Each of the rotor plates may have a third internal key located in the first axial keyway. A second end plate having a second internal key may be located in a second circumferential keyway. The first end plate and the second end plate may be on opposite sides of the rotor plates. The first axial keyway may extend from the first step in the shaft to at least the second circumferential keyway. Alternatively, the shaft may define a second axial keyway extending from a second step in the shaft at least to the second circumferential keyway. In yet another alternative, the second end plate may abut a shoulder in the shaft. The end plates may be made of a different material than the rotor plates.

A method of assembling a rotor includes sliding a rotor plate and a first end plate onto a shaft. The shaft has a first axial keyway and a first circumferential keyway. The first end plate has a first key which slides within the first axial keyway. After sliding the first end plate onto the shaft, the first end plate is rotated such that the first key engages the first circumferential keyway. The rotor plates may also have keys engaging the first axial keyway. The method may also include sliding a second end plate onto the shaft. The second end plate may have a second key which slides within the first axial keyway. After sliding the second end plate onto the shaft, the second end plate is rotated such that the second key engages a second circumferential keyway in the shaft. The first end plate, the second end plate, and the rotor plate may all slide onto the shaft from a first end of the shaft. Alternatively, the first and second end plates may be slid onto the shaft from opposite ends of the shaft. Alternatively, the second key may slide within a second axial keyway in the shaft. In yet another alternative, the second end plate may abut a shoulder in the shaft.

A motor includes a stator, a rotor shaft, a plurality of rotor plates, and first and second end plates. The rotor shaft is supported for rotation with respect to the stator. Each of the rotor plates has permanent magnets. The rotor plates are fixed to the rotor shaft and axially compressed between the first end plate and the second end plate. The first end plate has a first key engaging a first circumferential keyway in the rotor shaft. The second end plate may abut a shoulder in the rotor shaft. The rotor shaft may define a second circumferential keyway. The second end plate may have a second key engaging the second axial keyway. The rotor shaft may define an axial keyway extending from a first step in the shaft, past the first circumferential keyway, at least to the second circumferential keyway. Alternatively, the rotor shaft may defines a first axial keyway extending from a first step in the shaft at least to the first circumferential keyway and a second axial keyway extending from a second step in the shaft at least to the second circumferential keyway.

### BRIEF DESCRIPTION OF THE DRAWINGS

FIG. 1 is a block diagram of an electric vehicle.

FIG. 2 is a schematic cross sectional view of an electric motor.

FIG. 3 is pictorial view of a rotor of a permanent magnet electric motor.

FIG. 4 is a pictorial view of a first rotor shaft suitable for use in the rotor of FIG. 3.

FIG. 5 is a pictorial view of the rotor shaft of FIG. 4 with two end plates installed.

FIG. 6 is a pictorial view of the rotor shaft of FIG. 4 with one end plate and one rotor plate installed.

FIG. 7 is a cross sectional view of the rotor of FIG. 3.

FIG. 8 is a pictorial view of a second rotor shaft suitable for use in the rotor of FIG. 3.

FIG. 9 is a pictorial view of a third rotor shaft suitable for use in the rotor of FIG. 3.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

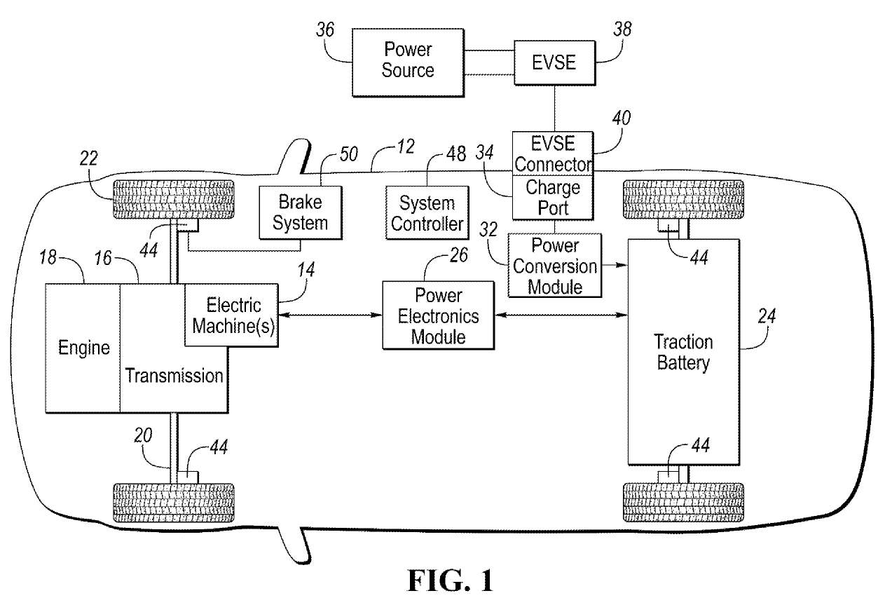

Referring now to FIG. 1, a block diagram of an exemplary electric vehicle (“EV”) 12 is shown. In this example, EV 12 is a plug-in hybrid electric vehicle (PHEV). EV 12 includes one or more electric machines 14 (“e-machines”) mechanically connected to a transmission 16. Electric machine 14 is capable of operating as a motor and as a generator. Transmission 16 is mechanically connected to an engine 18 and to a drive shaft 20 mechanically connected to wheels 22. Electric machine 14 can provide propulsion and slowing capability while engine 18 is turned on or off. Electric machine 14 may reduce vehicle emissions by allowing engine 18 to operate at more efficient speeds and allowing EV 12 to be operated in electric mode with engine 18 off under certain conditions.

A traction battery 24 (“battery) stores energy that can be used by electric machine 14 for propelling EV 12. Battery 24 typically provides a high-voltage (HV) direct current (DC) output. Battery 24 is electrically connected to a power electronics module 26. Power electronics module 26 is electrically connected to electric machine 14 and provides the ability to bi-directionally transfer energy between battery 24 and the electric machine. For example, battery 24 may provide a DC voltage while electric machine 14 may require a three-phase alternating current (AC) voltage to function. Power electronics module 26 may convert the DC voltage to a three-phase AC voltage to operate electric machine 14. In a regenerative mode, power electronics module 26 may convert three-phase AC voltage from electric machine 14 acting as a generator to DC voltage compatible with battery 24.

Battery 24 is rechargeable by an external power source 36 (e.g., the grid). Electric vehicle supply equipment (EVSE) 38 is connected to external power source 36. EVSE 38 provides circuitry and controls to control and manage the transfer of energy between external power source 36 and EV 12. External power source 36 may provide DC or AC electric power to EVSE 38. EVSE 38 may have a charge connector 40 for plugging into a charge port 34 of EV 12. Charge port 34 may be any type of port configured to transfer power from EVSE 38 to EV 12. A power conversion module 32 of EV 12 may condition power supplied from EVSE 38 to provide the proper voltage and current levels to battery 24. Power conversion module 32 may interface with EVSE 38 to coordinate the delivery of power to battery 24. Alternatively, various components described as being electrically connected may transfer power using a wireless inductive coupling.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 48 (i.e., a vehicle controller) is present to coordinate the operation of the various components.

As described, EV 12 is in this example is a PHEV having engine 18 and battery 24. In other embodiments, EV 12 is a battery electric vehicle (BEV). In a BEV configuration, EV 12 does not include an engine.

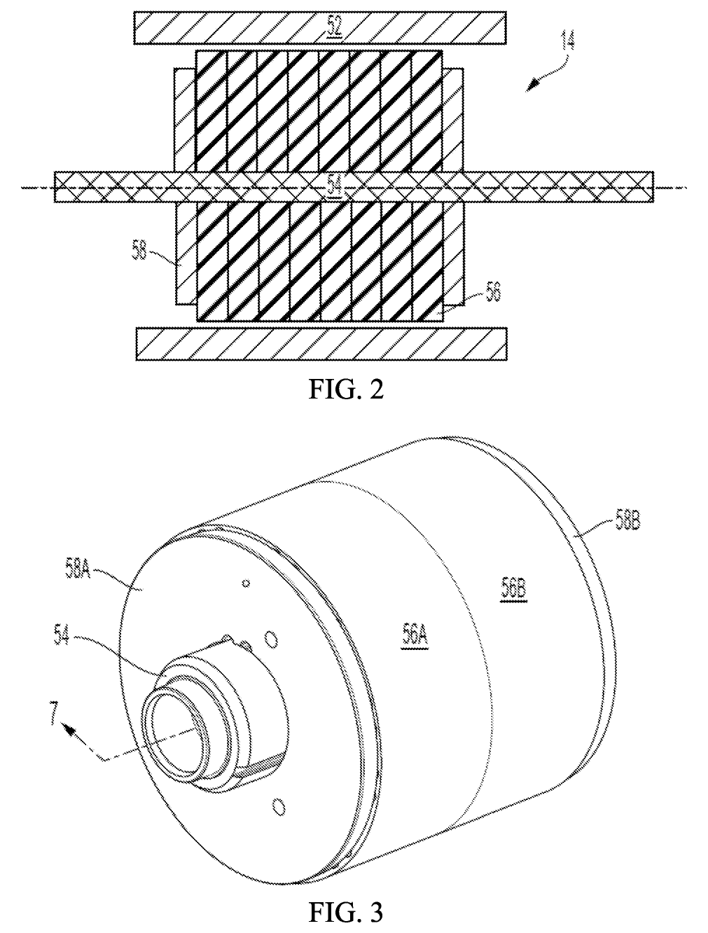

FIG. 2 illustrates an electric motor. Stator 52 is fixed to vehicle structure. A set of electrical windings are installed on stator 52 to create magnetic fields by adjusting the current level in the wires. Rotor shaft 54 is supported for rotation with respect to the stator and adapted for rotary connection to powertrain components. A set of rotor plates 56 are rotationally coupled to rotor shaft 54. End plates 58 may be attached to the rotor shaft on each axial end of the set of rotor plates. The end plates may be made of a different material than the rotor plates. Each rotor plate has a set of permanent magnets installed with alternating polarity. The magnetic field of the permanent magnets interacts with the magnetic field produced by the stator winding to create torque which is transmitted to the rotor shaft.

FIG. 3 is a pictorial view of the rotor assembly of the motor of FIG. 2. In this example, there are two rotor plates, 56A and 56B between a left end plate 58A and a right end plate 568B. The rotor plates are made of magnetically conductive material and hold a set of permanent magnets in a defines pattern to create a series of alternating North and South magnetic poles around their perimeters. End plates 58A and 58B may be made of a different material than the rotor plates such as aluminum.

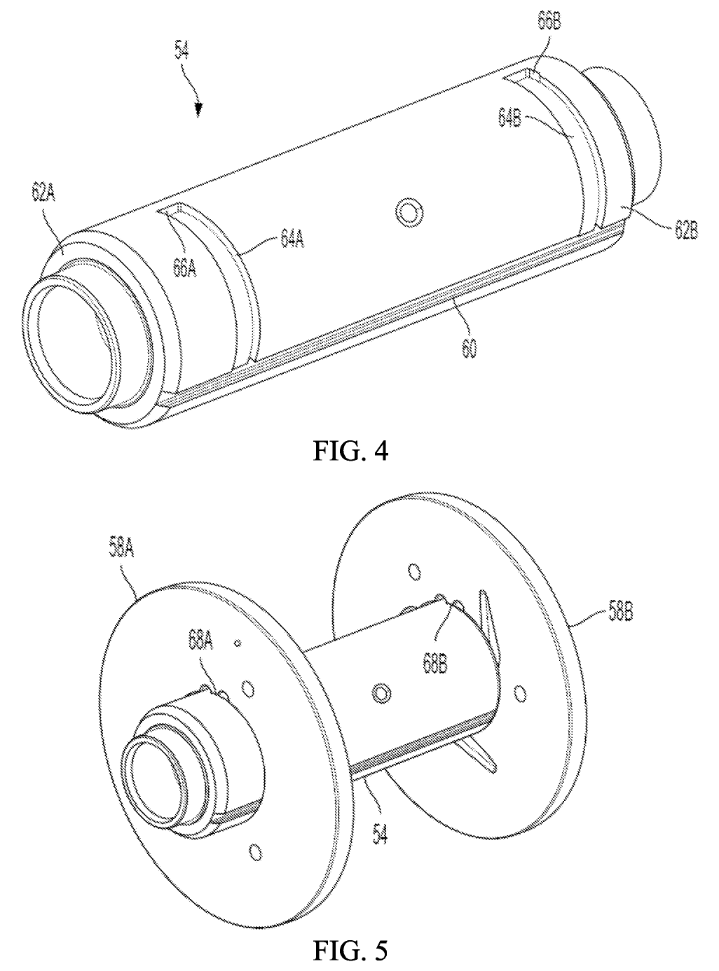

FIG. 4 is a pictorial view of rotor shaft 54 according to a first embodiment. Rotor shaft 54 defines an axial keyway 60. A keyway is a groove designed to engage with a key on a mating component to prevent relative movement of the mating component. An axial keyway runs parallel to a shaft axis. The interaction of a key and an axial keyway prevents rotation with respect to the shaft. Axial keyway 60 extends between a left step 62A and a right step 62B in the shaft. A step in a shaft is an axial location at which the shaft diameter changes. (An end of a shaft is a step but shafts may have other steps.) As a mating component slides over s step, a key may begin engaging a keyway that begins at the step. Rotor shaft 54 also defines two circumferential keyways 64A and 64B. A circumferential keyway extends along an arc predominantly perpendicular to the shaft axis. The circumferential keyways 64A and 64B intersect the axial keyway 60. In the illustrated embodiment, the circumferential keyways extend roughly 90 degrees around the shaft, although that may differ in other embodiments. Circumferential keyway 66A has a notch 68A at which it is slightly wider in a direction towards the left end of the shaft. Similarly, circumferential keyway 66B has a notch 66B at which it is slightly wider in a direction towards the right end of the shaft.

FIG. 5 is a pictorial view of the rotor shaft 54 with end plates 58A and 58B in place. Rotor plates 56A and 56B are not show so that the connections between the shaft and the end plates are visible. End plate 58A has an internal key 68A which engages circumferential keyway 64A. More specifically, axial separating forces imposed on end plate 58A by the rotor plates lock key 68A in notch 66A preventing end plate 58A from rotating with respect to shaft 54. Similarly, end plate 58B has an internal key 68B which rests in notch 66B of circumferential keyway 64B. The end plates are installed by sliding the key along axial keyway 60 from one of the steps to the point at which axial keyway 60 intersects the appropriate circumferential keyway. Then, the end plate is rotated with respect to the rotor shaft 54 with the key sliding within the circumferential keyway. In the illustrated embodiment, the first of the two end plates to be installed could be installed from either end. In alternate embodiments, the axial keyway may not extend to the second step, so both end plates would need to be installed from the same end of the rotor shaft. As discussed below, the rotor plates are installed on the shaft prior to installing the second end plate. In the installed condition, the end plates compress the rotor plates.

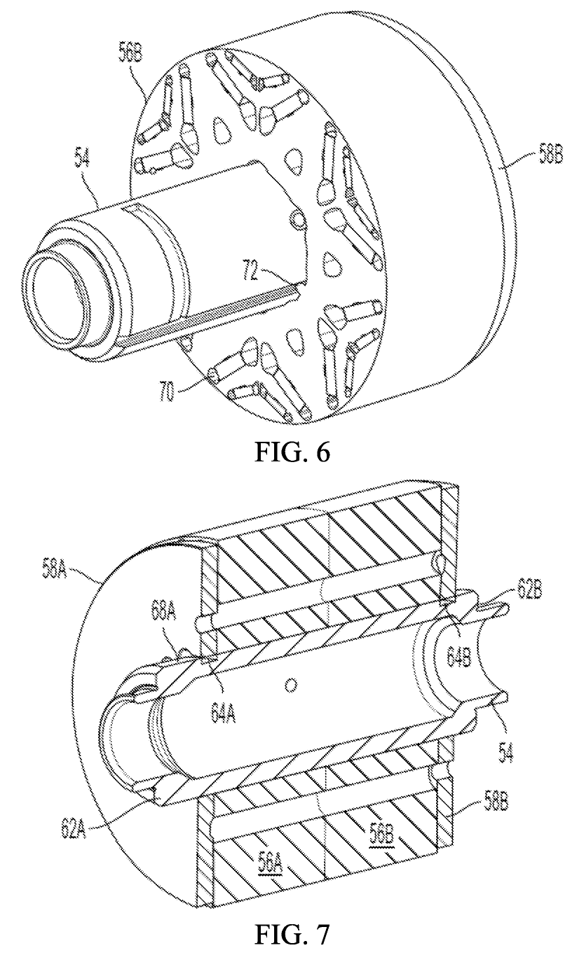

FIG. 6 is a pictorial view of the motor of FIG. 2 after one of the end plates 58B and one of the rotor plates 56B have been installed on the rotor shaft 54. The rotor plate 56B includes a set of permanent magnets 70 that are installed in slots. The rotor plate also has an internal key 72. Internal key 72 engages axial keyway 60 to prevent relative rotation between the rotor plate and the rotor shaft. Torque generated by the motor may be transmitted to the rotor shaft via key 72. The keys in the rotor plates ensure that the magnetic fields of the various rotor plates are aligned with one another (or, if skew is desired, that they are slightly offset from one another). Rotor plate 56B is installed on the shaft by sliding it on from one end with key 72 sliding in axial keyway 60. If the rotor plate is installed before either end plate, then it can be slid onto the shaft from either end.

FIG. 7 is a cross sectional view of the assembled rotor. The rotor plates 56A and 56B are held in place axially by the end plates 58A and 58B. The end plates, in turn, are held in place axially by keys 68A and 68B in circumferential keyways 64A and 64B.

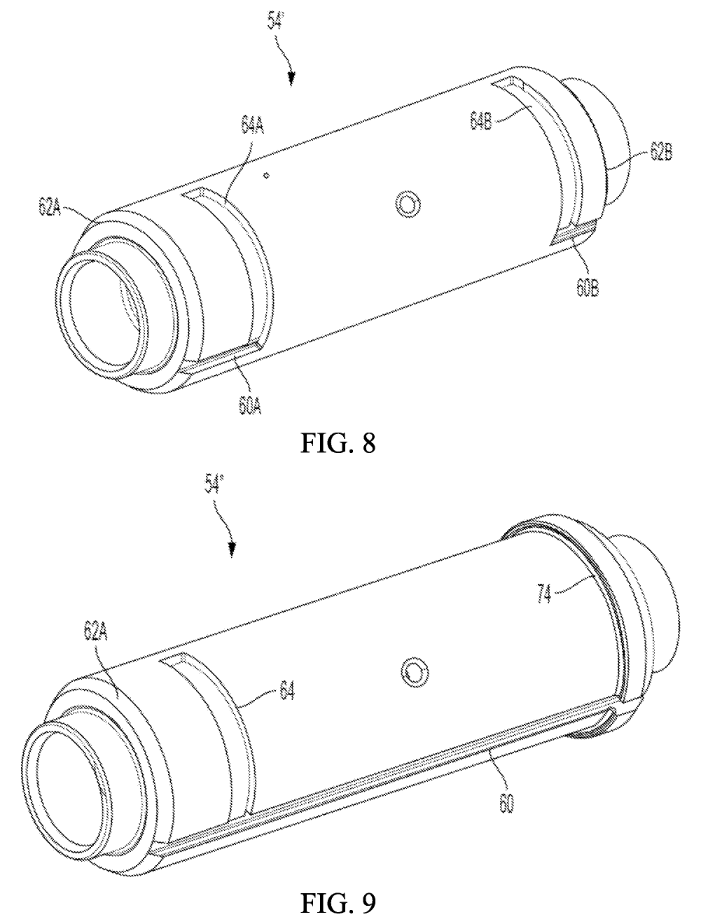

FIG. 8 is a rotor shaft 54ʹ according to a second embodiment. Rotor shaft 54ʹ defines a left axial keyway 60A extending from a left step 62A to a left circumferential keyway 64A. Similarly, a right axial keyway 60B extending from a right step 62B to a right circumferential keyway 64B. In this embodiment, end plate 58A is slid on from the left end of the rotor shaft 54ʹ and end plate 58B is slid on from the right end. Rotor plates 56A and 56B are slid onto rotor shaft 54ʹ before the second of end plates 58A and 58B are slid onto the shaft. Some other provision is made for rotationally fixing the rotor plates to the rotor shaft. For example, a separate axial keyway may be on an opposite side of the shaft out of view in FIG. 8.

FIG. 9 is a rotor shaft 54ʹʹ according to a third embodiment. Rotor shaft 54ʹʹ defines a shoulder 74 near the right end of the shaft. Axial keyway 60 extending from a left step 62A, past circumferential keyway 64, to the shoulder 74. In some embodiments, axial keyway 60 may not extend this far to the right. In the third embodiment, both end plates and the rotor plates are slid onto the rotor shaft from the left end in a particular order. First, end plate 58B is slid on such that it abuts shoulder 74. Then rotor plates 56B is slid on such that it abuts end plate 58B. Rotor plate 56A is slid on such that it abuts rotor plate 56B. The keys of the rotor plates slide in axial keyway 60. Finally, end plate 58A is slid on until key 68A lines up axially with circumferential keyway 64. From there, end plate 58A is rotated with respect to rotor shaft 54ʹʹ such that end plate 58A is axially locked into position by circumferential keyway 64.

While exemplary embodiments are described above, it is not intended that these embodiments describe all possible forms encompassed by the claims. Features of the first, second, and third embodiments may be combined in various ways to produce other embodiments. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A rotor comprising:
a shaft defining a first circumferential keyway and a first axial keyway, the first axial keyway extending from a first step in the shaft at least to the first circumferential keyway;
a first end plate having a first internal key located in the first circumferential keyway to prevent axial movement of the first end plate; and
at least one rotor plate rotationally fixed to the shaft on a side of the first end plate opposite the first step in the shaft.

2. The rotor of claim 1 wherein the first circumferential keyway extends only partially around the shaft.

3. The rotor of claim 1 wherein:
the first circumferential keyway defines a notch facing toward the first step in the shaft; and
the first internal key is located in the notch.

4. The rotor of claim 1 further comprising a second end plate having a second internal key located in a second circumferential keyway, wherein the first end plate and the second end plate are on opposite sides of the at least one rotor plate.

5. The rotor of claim 4, wherein the first axial keyway extends from the first step in the shaft to at least the second circumferential keyway.

6. The rotor of claim 5, wherein each of the at least one rotor plates has a third internal key located in the first axial keyway.

7. The rotor of claim 4, wherein the shaft defines a second axial keyway extending from a second step in the shaft at least to the second circumferential keyway, the first step in the shaft and the second step in the shaft being on opposite ends of the shaft relative to the at least one rotor plate.

8. The rotor of claim 1, further comprising a second end plate abutting a shoulder in the shaft and wherein the first end plate and the second end plate are on opposite sides of the at least one rotor plate.

9. The rotor of claim 1 wherein the first end plate is made of a different material than the at least one rotor plate.

10. A method of assembling a rotor comprising:
sliding at least one rotor plate onto a shaft, the shaft having a first axial keyway and a first circumferential keyway;
sliding a first end plate onto the shaft, the first end plate having a first key which slides within the first axial keyway; and
after sliding the first end plate onto the shaft, rotating the first end plate such that the first key engages the first circumferential keyway.

11. The method of claim 10 further comprising:
sliding a second end plate onto the shaft, the second end plate having a second key which slides within the first axial keyway; and
after sliding the second end plate onto the shaft, rotating the second end plate such that the second key engages a second circumferential keyway in the shaft.

12. The method of claim 11, wherein the first end plate, the second end plate, and the at least one rotor plate are all slid onto the shaft from a first end of the shaft.

13. The method of claim 10 further comprising:
sliding a second end plate onto the shaft, the second end plate having a second key which slides within a second axial keyway in the shaft; and
after sliding the second end plate onto the shaft, rotating the second end plate such that the second key engages a second circumferential keyway in the shaft.

14. The method of claim 13, wherein the first end plate is slid onto the shaft from a first end of the shaft and the second end plate is slid onto the shaft from a second end of the shaft opposite the first end of the shaft.

15. The method of claim 10 further comprising sliding a second end plate onto the shaft prior to sliding the first end plate and the at least one rotor plate onto the shaft, such that the second end plate abuts a shoulder in the shaft.

16. The method of claim 10 wherein the at least one rotor plate has a third key engaging the first axial keyway.

17. A motor comprising:
a stator;
a rotor shaft supported for rotation with respect to the stator; and
a plurality of rotor plates, each having permanent magnets, fixed to the rotor shaft and axially compressed between a first end plate and a second end plate; wherein
the first end plate has a first key engaging a first circumferential keyway in the rotor shaft.

18. The motor of claim 17 wherein:
the rotor shaft defines a shoulder; and
the second end plate abuts the shoulder.

19. The motor of claim 17, wherein:
the rotor shaft defines a second circumferential keyway;
the second end plate has a second key engaging the second circumferential keyway; and
the rotor shaft defines an axial keyway extending from a first step in the shaft, past the first circumferential keyway, at least to the second circumferential keyway.

20. The motor of claim 17, wherein:
the rotor shaft defines a second circumferential keyway;
the second end plate has a second key engaging the second circumferential keyway;
the rotor shaft defines a first axial keyway extending from a first step in the shaft at least to the first circumferential keyway; and
the rotor shaft defines a second axial keyway extending from a second step in the shaft at least to the second circumferential keyway.
